(19) United States
(12) Patent Application Publication
(10) Pub. No.: US 2011/0241445 A1
(43) Pub. Date: Oct. 6, 2011

(54) Transceiver Interface

(75) Inventors: Ross Teggatz, McKinney, TX (US); Wayne Chen, Plano, TX (US); Brett Smith, McKinney, TX (US)

(73) Assignee: TRIUNE IP LLC, Richardson, TX (US)

(21) Appl. No.: 13/080,579

(22) Filed: Apr. 5, 2011

Related U.S. Application Data
(60) Provisional application No. 61/321,109, filed on Apr. 5, 2010.

(51) Int. Cl. H02B 1/24

(52) U.S. Cl. 307/127

(57) ABSTRACT

A transceiver interface is disclosed in which a true positive node and a true ground node are maintained with three adaptive terminals. The adaptive terminals each have pairs of isolation elements linking them to the true positive node and true ground node, whereby, each of the adaptive terminals can function as a positive terminal, ground terminal, and transceiver terminal, in response to how the interface is connected to external equipment.

### PRIORITY ENTITLEMENT

This application is entitled to priority based on Provisional Patent Application Ser. No. 61/321,109 filed on Apr. 5, 2010, which is incorporated herein for all purposes by this reference. This application and the Provisional Patent Applications have at least one common inventor.

### TECHNICAL FIELD

The invention relates to communication devices and systems. In particular, the invention is directed to communications apparatus and transceiver interfaces having three terminals, namely a power terminal, ground terminal, and a signal terminal used for communication input/output.

### BACKGROUND OF THE INVENTION

It is known to provide transceiver systems having interfaces with at least three terminals for making connections with external circuits and systems. A positive terminal and a ground terminal are typically provided for connection to an external power source. A bidirectional signal terminal is provided for transmitting and receiving communication signals. A transceiver of common design can be damaged in the event one or more of the terminals is inadvertently connected improperly. An additional problem in some transceiver systems is that the transceiver circuitry can be abruptly shut off when the power from the supply side is interrupted or turned off. In some systems, not supplying power for a shut-down sequence can be detrimental.

Due to these and other problems and potential problems, improved transceivers with dynamically adaptable terminals and shut-down power circuitry would be would be useful and advantageous contributions to the arts.

### SUMMARY OF THE INVENTION

In carrying out the principles of the present invention, in accordance with preferred embodiments, the invention provides advances in the arts with novel methods and apparatus directed to providing transceiver interfaces with terminals suitable for use as power, ground, and signal terminals depending upon how they are connected to associated circuitry. Additional circuitry can also be included to provide adequate power for operating a shut-down sequence when the transceiver power supply is abruptly interrupted.

According to one aspect of the invention, in an example of a preferred embodiment, a novel transceiver interface includes a true positive node and a true ground node coupled with three adaptive terminals. The adaptive terminals have pairs of isolation elements linking them to the true positive node and the true ground node. Each of the adaptive terminals is configured to function as a positive terminal, ground terminal, and transceiver terminal.

According to another aspect of the invention, in a presently preferred embodiment, diodes perform the function of isolation elements coupling the terminals to the power and ground nodes for controlled current flow.

According to still another aspect of the invention, in examples of preferred embodiments, the transceiver interface also includes a charge storage element for providing power during system shut-down.

According to additional aspects of the invention, preferred embodiment of the transceiver interface also include a detection circuit for monitoring the status of one or more of the terminals.

The invention has advantages including but not limited to one or more of the following, providing a robust, user-friendly, adaptable transceiver interface, and providing a transceiver interface with an improved shut-down power capability. These and other advantageous features and benefits of the present invention can be understood by one of skilled in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a simplified schematic circuit diagram illustrating an example of preferred embodiments of circuits, systems, and methods according to the invention; and

FIG. 2 is a simplified schematic circuit diagram illustrating another example of preferred embodiments of circuits, systems, and methods according to the invention.

References in the detailed description correspond to like references in the various drawings unless otherwise noted. Descriptive and directional terms used in the written description such as right, left, back, top, bottom, upper, side, et cetera, refer to the drawings themselves as laid out on the paper and not to physical limitations of the invention unless specifically noted. The drawings are not to scale, and some features of embodiments shown and discussed are simplified or amplified for illustrating principles and features, as well as anticipated and unanticipated advantages of the invention.

### DESCRIPTION OF PREFERRED EMBODIMENTS

A transceiver interface is disclosed in a configuration by which signals may be transmitted over a single signal terminal, and separate power and ground terminals are also provided. The terminals are each configured to act as either a power, ground, or signal terminal, depending upon how it is connected to associated communication system equipment.

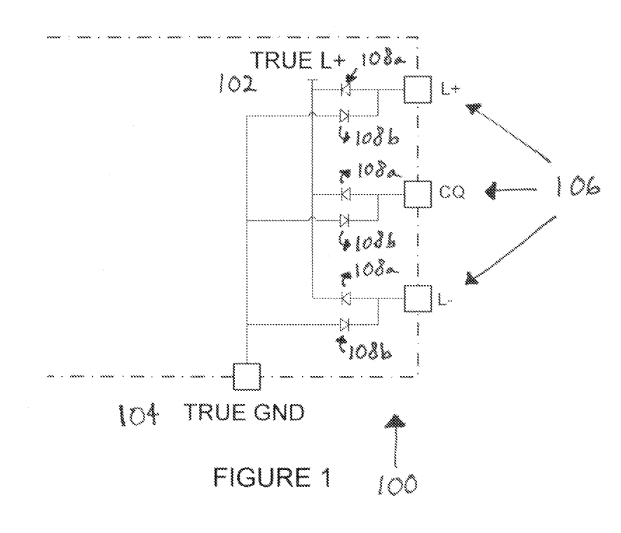

As shown in the exemplary embodiment of FIG. 1, the transceiver interface 100 has a “true” power node 102 and a “true” ground node 104. Three adaptive terminals, 106 ultimately connect with the true power and ground nodes 102, 104. Interposed between each adaptive terminal 106 and the power and ground nodes 102, 104, however, are isolation elements 108. In this example of a preferred embodiment of the invention, the isolation elements are diodes 108. Preferably, the isolation elements 108 act as current valves, permitting electric current to flow in one direction only. As can be seen in FIG. 1, the power node 102 is electrically coupled to each of the adaptive terminals 106 through a diode 108a configured to permit current to flow in one direction. Similarly, the ground node 104 is electrically coupled to each adaptive terminal 106 through a diode 108b configured to permit current to flow in the direction opposite to the direction used for the power node 102 connections. The isolation elements may be any electrical component or element suitable to permit current flow in one direction. It is contemplated that rectifying diodes, flyback diodes, Schottkey diodes, Zener diodes, veractor diodes, tunnel diodes, super-barrier diodes, or suitable transistors may be used without departure from the principles of the invention.

In operation, the transceiver terminal 100 uses the diodes 108a-b to adaptively provide the appropriate electrical connections to the power node 102 and ground node 104 regardless of how connections are made at the terminal 106. These isolation elements, in this case diodes, correct the polarity for internal supplies within the transceiver 100, ensuring that the interface is robust and fault tolerant, regardless of how the terminals 106 are connected to external devices. The systems shown and described herein are typical of a three-wire I/O Link system for the purposes of example. It should be appreciated by those skilled in the arts that the interface may also be readily adapted for use with other communications systems as well.

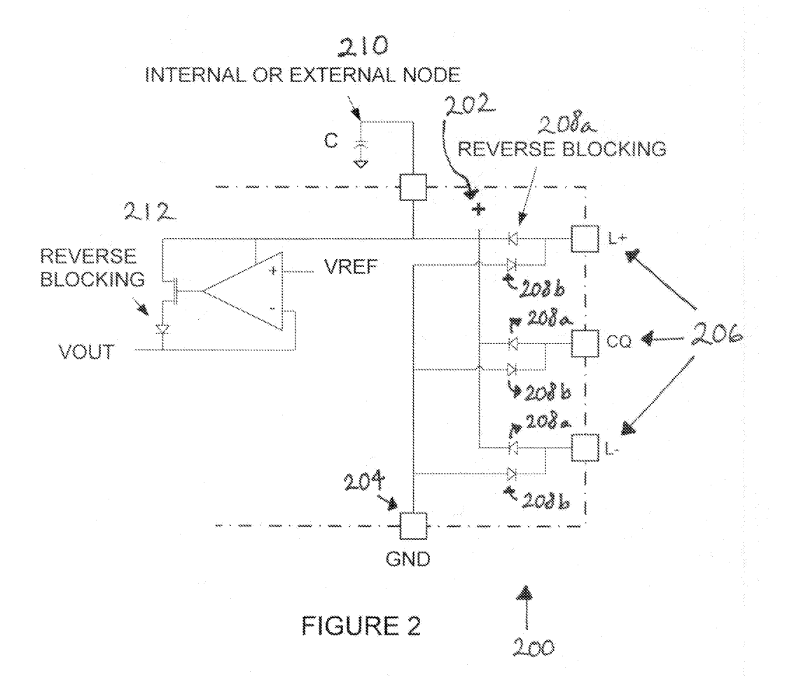

Now referring primarily to FIG. 2, a transceiver terminal circuit 200 is shown in a simple schematic. A power node 202 and a ground node 204 are provided. Three adaptive terminals 206 are also provided as in the above-described embodiment for electrically connecting the adaptive terminals 206 with the “true” power and ground nodes 202, 204. The isolation elements 208 are interposed between each adaptive terminal 206 and the power and ground nodes 202, 204, permitting current to flow in one direction only. As shown, the power node 202 is electrically coupled to each of the adaptive terminals 206 for current flow in one direction, e.g., using diodes 208a. The ground node 204 is also electrically coupled to each adaptive terminal 206 for current flow in the opposite direction, e.g., diodes 208b. The isolation elements may be any electrical component or element suitable to permit current flow in one direction, although diodes are presently preferred.

In addition, in this example of a preferred embodiment of a transceiver interface, the circuit 200 provides a supplemental charge storage element 210 electrically coupled to the power node 202 in an arrangement through which, when the power node 202 is grounded or turned-off, the transceiver side of the system, e.g., adaptive terminals 206, are provided power by the power storage element 210. This configuration 200 is useful and advantageous in that it provides supplemental power for shut-down procedures in the event that the main power node 202 abruptly stops supplying power. The power storage element 210 may be a storage capacitor, super-capacitor, battery, or other electrical component suitable for storing power. Also shown in FIG. 2, the terminal circuitry 200 may also include a detection circuit 212, used to monitor the nodes and/or terminals in order to make a determination of whether any given terminal or node is on, off, or disconnected.

While the making and using of various exemplary embodiments of the invention are discussed herein, it should be appreciated that the present invention provides inventive concepts which can be embodied in a wide variety of specific contexts. It should be understood that the invention may be practiced with electronic apparatus and systems having additional terminals for additional signals, power supplies, and the like, in addition to the simplified three-terminal embodiments shown and described for illustration purposes. For example, additional terminals and nodes may be included in an interface in the manner described without departing form the invention. For purposes of clarity, detailed descriptions of functions, components, and systems familiar to those skilled in the applicable arts are not included. The methods and apparatus of the invention provide one or more advantages including but not limited to, dynamically adaptable electrical connections and supplemental stored power circuits for short-term use. While the invention has been described with reference to certain illustrative embodiments, those described herein are not intended to be construed in a limiting sense. For example, variations or combinations of steps or materials in the embodiments shown and described may be used in particular cases without departure from the invention. Various modifications and combinations of the illustrative embodiments as well as other advantages and embodiments of the invention will be apparent to persons skilled in the arts upon reference to the drawings, description, and claims.

We claim:

1. A transceiver interface comprising:
a true positive node;
a true ground node; and
three adaptive terminals; wherein
each of the adaptive terminals further comprises;
an isolation element linking it to the true positive node; and
an isolation element linking it to the true ground node; whereby
each of the adaptive terminals is adapted to function as a positive terminal, ground terminal, and transceiver terminal.

2. The transceiver interface according to claim 1 wherein the isolation elements comprise diodes.

3. The transceiver interface according to claim 1 wherein the isolation elements comprise rectifying diodes.

4. The transceiver interface according to claim 1 wherein one or more of the isolation elements comprise transistors.

5. The transceiver interface according to claim 1 further comprising a charge storage element for providing backup voltage.

6. The transceiver interface according to claim 1 further comprising a capacitor for providing backup voltage.

7. The transceiver interface according to claim 1 further comprising a battery for providing backup voltage.

8. The transceiver interface according to claim 1 further comprising a detection circuit for monitoring the status of one or more of the terminals.

9. A transceiver interface comprising:
a true positive node;
a true ground node;
three adaptive terminals; wherein
each of the adaptive terminals further comprises;
an isolation element linking it to the true positive node; and
an isolation element linking it to the true ground node; whereby
each of the adaptive terminals is adapted to function as a positive terminal, ground terminal, and transceiver terminal; and
a charge storage element operably coupled for providing charge to one or more of the adaptive terminals.

10. The transceiver interface according to claim 9 wherein the isolation elements comprise diodes.

11. The transceiver interface according to claim 9 wherein the isolation elements comprise rectifying diodes.

12. The transceiver interface according to claim 9 wherein one or more of the isolation elements comprise transistors.

13. The transceiver interface according to claim 9 wherein the charge storage element further comprises one or more capacitors.

14. The transceiver interface according to claim 8 further comprising a detection circuit for monitoring the status of one or more of the terminals.

15. A transceiver interface comprising:
a positive node;
a ground node;
three adaptive terminals; wherein
each of the adaptive terminals further comprises;
an isolation element linking it to the positive node; and
an isolation element linking it to the ground node; whereby
each of the adaptive terminals is adapted to function as a positive terminal, ground terminal, and transceiver terminal;
a charge storage element operably coupled for providing charge to one or more of the adaptive terminals; and
a detection circuit for monitoring the status of one or more of the terminals.

16. The transceiver interface according to claim 15 wherein the isolation elements comprise diodes.

17. The transceiver interface according to claim 15 wherein the isolation elements comprise rectifying diodes.

18. The transceiver interface according to claim 15 wherein one or more of the isolation elements comprise transistors.

19. The transceiver interface according to claim 15 wherein the charge storage element further comprises one or more capacitors.

20. The transceiver interface according to claim 15 wherein the detection circuit further comprises an op amp.

21. The transceiver interface according to claim 15 wherein the detection circuit further comprises a regulator circuit.
